(19) United States
(12) Patent Application Publication
(10) Pub. No.: US 2004/0015912 A1
(43) Pub. Date: Jan. 22, 2004

(54) Method of byte code quickening: quick instructions for method invocation

(76) Inventor: Thomas Mark Walter Bottomley, Orleans (CA)

Correspondence Address: SMART & BIGGAR, P.O. BOX 2999, STATION D, 55 METCALFE STREET, SUITE 900, OTTAWA, ON, K1P5Y6, CA

(21) Appl. No.: 09/956,130

(22) Filed: Sep. 20, 2001

Related U.S. Application Data
(60) Provisional application No. 60/252,170, filed on Nov. 20, 2000.
(60) Provisional application No. 60/276,375, filed on Mar. 16, 2001.

(51) Int. Cl. G06F 9/45

(52) U.S. Cl. 717/148; 717/131

(57) ABSTRACT

A method of method invocation quickening is provided. Standard Java and Java-like applications use a relatively small number of static methods in comparison to the number of classes required, and the associated methods use a relatively small number of arguments in comparison to the number of virtual methods of a class. Known method invocation quickening instructions use operands which specify indices to locate classes, virtual methods, static methods, and specify numbers of arguments of virtual methods. Current allocation of bit-length to operands are inefficient due to the lack of correspondence with the relative sizes of numbers of items indexed or represented by the operands. The herein invention discloses a system and a method to more efficiently allocate the number of bits used in quickened invocation of virtual and static methods by allocating fewer bits to those operands which index items of a relative small number, and allocate more bits to those operands which index items having relatively larger numbers.

### FIELD OF THE INVENTION

This invention relates to systems and methods providing runtime instruction optimization of platform independent instruction set, such as Java-like languages.

### BACKGROUND OF THE INVENTION

In software systems implementing platform independent languages such as Java™ or Java-like languages, in addition to an application program run by an operating system on a processor connected to a number of hardware peripherals, there is a virtual machine, for example, a Java Virtual Machine (JVM) situated between the operating system and the application program. When the platform independent instruction set is implemented in hardware to execute a Java-like language, instead of a virtual machine being situated between an operating system and the application program, a firmware implementation of the virtual machine is present taking the form of a Java-like machine. As such in the context of a platform independent language such as Java, a language specific machine such as a Java machine is present in a processor implementation of a platform independent language such as JVM. The Java or Java-like code is executed by the Java or Java-like machine as it would in the virtual machine, essentially as a byte-code interpreter.

Although specific reference will be made to Java throughout this document it should be understood that this is done only by way of example and that the actual subject matter of the present invention is generally any platform independent instruction set.

Java™, is a programming language marketed by Sun Microsystems, Inc. Java is an architecture-neutral, object-oriented, multi-threaded language intended for use in distributed environments. It has become tremendously popular among application developers, and its use on handheld and wireless platforms has been growing by leaps and bounds. The Java or Java-like programming language may include, but is not limited to Java 2 Platform, Enterprise Edition (J2EETM), Java 2 Platform, Standard Edition (J2SETM), and Java 2 Platform, Micro Edition (J2METM) programming languages available from Sun Microsystems, all of which are incorporated herein by reference. Both J2SE and J2ME provide a standard set of Java programming features, with J2ME providing a subset of the features of J2SE for programming platforms that have limited memory and power resources (i.e., including but not limited to cell phones, PDAs, etc.), while J2EE is targeted at enterprise class server platforms.

Referring to FIG. 4, a system block diagram, a Java method is run on a Java Machine (JM) 140 which may be a Java Virtual Machine (JVM) or a hardware implementation or an implementation using a combination of hardware and software or just software. The JM 140 is divided into conceptual data spaces including a class area 138, a heap 170, and a Java stack 160 per thread. The class area 138 has within it loaded classes and includes for each class a constant pool 137, a method area 136, and a vtable 139, also known as a method table. The heap contains object instances 172 some of which will be receiver objects 174 methods are invoked upon. In any frame of the Java stack 160, which exists for every thread, is an operand stack 162, and a local variable array 164. Other components of the JM include a class loader 134, a standard Java instruction set 200, a quickening function 146, and various other well known custom “quick” byte codes (or more generally “quick” instructions 202) such as “invokevirtual_quick” 203. Associated inputs to the JM include class files 130 which describe classes and includes for each class a constant pool 132, and method entries 133.

A Java method consists of a sequence of Java byte codes. Each byte code is one byte, and there are 256 possible byte codes. However, standard instruction sets 200 for some standardized implementations of Java typically use only 202 of these byte codes called “standard byte codes”. Further optimizations and substitutions can free up some of these 202 byte codes. The instruction set also typically includes over 20 commonly recognized runtime optimization “quick” instructions 202, which are not part of the standard instruction set 200 but are well known and part of the Java Virtual Machine Specification Version 1.

The class loader 134 loads classes from class files 130 into the class area 138 where classes are stored in the system. The class loader 134 also uses semantic information carried on the standard byte codes used by a verification portion of the class loader 134 (not shown) to check all classes for structure, environment, and content. The class area 138 contains method code in a method area 136 and loaded constants in the constant pool 137. A typical Java method includes a name, calling signature(arguments), and the actual Java code. Native processor methods however do not include Java code.

In general to invoke a virtual method on a receiver object 174 on the heap 170, an invocation byte code requires an identification of the method called as an operand. Typically this would include references to the constant pool 137 for the class of the method, a name for the method, and a descriptor which details the arguments and return types of the method. In Java, a standard invokevirtual byte code is used to invoke a virtual method. Additionally, in order to execute the invokevirtual byte code, the operand stack 162 of the Java Stack 160 must contain a reference to the receiver object 174 the method is being invoked upon, and any arguments the method requires.

Referring to FIG. 4, a class file 130 can define a set of constants in an area called the constant pool 132. The constant pool 132 contains constant values where they can be easily referenced elsewhere in the class. The constant pool of loaded classes in the class area 138 is shown as 137 in FIG. 4. Often a constant pool entry will refer to another constant pool entry, using two-byte unsigned integer indices into the constant pool 137. Java code 136 may itself include references to entries in the constant pool 137. A constant pool entry can also be a reference to a method, in which case the entry is called a Methodref. A Methodref entry can be referred to as the method for invocation on a receiver object 174. Instead of an invokevirtual byte code being passed the full name and type of the method being invoked, it is merely passed an index to a Methodref entry in the constant pool 137. A Methodref contains the method reference class number, name and type. At run time these constant pool method references must be “resolved” when invoking virtual methods of the constant pool 137 on receiver objects 174. This “method resolution” includes the steps of locating the method reference class, the name and type, and the descriptor. Once completed the resolution process provides enough information to name and identify the method being called.

Referring to FIG. 1, the following is an example of virtual method resolution through a class's constant pool 137. FIG. 1 shows extracts from a constant pool. In Java, an integer preceded by a “#” refers to the constant pool entry indexed by that integer. As mentioned above, when an invokevirtual byte code is to be executed, a reference to the receiver object 174 and the arguments of the method should already be on the operand stack 162. When an invokevirtual byte code is to be executed using a reference to an entry in the constant pool 137, for example “invokevirtual #21”, constant pool entry 21 is located. Constant pool entry 21 is a Methodref constant: “Methodref class #10 and name-and-type #37”. A Methodref constant indicates other entries in the constant pool 137, one being a name for the class the invoked method is a member of (#10), and the other one which points to a constant which contains a name and descriptor of the method (#37). These must also be located in the constant pool 137. Entry 10 is “Class name #84”, and constant pool entry 84 contains a name for the class “java/lang/String”. In this way a class name is identified. Constant pool entry 37 (name-and-type) is “NameAndType name #89 descriptor #44”. These further constant pool entries are located, entry 89 containing a name of the method “length”, and entry 44 containing a descriptor of the method “( )I” signifying a single integer return. Through resolution a Methodref “invokevirtual #21” is resolved to “invokevirtual java/lang/String/length ( )I”.

After resolution, a procedure of virtual dispatch typically occurs where the Java machine looks in the class of the receiver object 174 to find a method implementation with the exact name and type as identified through resolution of the operands to the invokevirtual byte code. If it exists it is executed, if not, the Java machine looks at the methods of a superclass of the receiver object. If the method is present the selection of a virtual override occurs at this point if a subclass has an overriding method defined. In this context of inheritance and possible method overrides, Java facilitates this process by keeping for every class a list created at class load-time, called a vtable 139, referring to all the methods of that class's superclass and all the methods of the class itself (the subclass). By keeping method entry pointers to methods which are common to the superclass, each subclass automatically inherits all the methods of the superclass. By keeping method entry pointers to methods specific to the subclass, new methods are easily added and referred to. When the subclass has its own implementation of a method and overrides the corresponding method of the superclass, the vtable 139 does not add a separate entry for the overriding method but instead replaces the reference to the overridden method of the superclass with a reference to the specific overriding method.

In optimizing the process of method invocation, there is a technique for “quickening” virtual method invocation. It is more efficient when a method is invoked, for the reference in the vtable 139 of that method to be known instead of performing the various look-up and comparison functions to resolve which exact method should be performed. At compile time however, the position of the method reference in the vtable 139 is unknown. The system of FIG. 4 includes a quickening function 146 which quickens virtual methods as will now be discussed with reference to FIG. 2. Quickening virtual methods typically involves a one time standard invocation of a method to be quickened causing resolution through the constant pool (or a resolution at class loading) at step 100, after which point in addition to the standard resolution procedure, the number of arguments of the method and the location of the method in the vtable 139 are found at step 102. Each one of the old invokevirtual byte codes used to invoke the method to be quickened is replaced by a new invoking byte code called invokevirtual_quick 203 (referred to above as a “quick” byte code, and part of the JVM Specification v.1) which use as operands a) the index in the vtable 139 which locates the specific method reference, and b) the number of arguments the method requires (step 104). The first operand avoids the need to perform the standard resolution procedure and the standard virtual dispatch process, by directly locating the appropriate method in the vtable 139. The second operand enables invokevirtual_quick to immediately locate the object reference on the operand stack 162, the number of arguments the method requires corresponding to a relative position of the reference to the receiver object 174 on the operand stack 162 when the invokevirtual_quick command is executed. Locating the object reference occurs without having to deduce this from the normal type definition of the called method, which in the normal procedure must be looked up through the process of method resolution. At class loading, the invokevirtual byte codes can be replaced with invokevirtual_quick byte codes or alternatively it can be done at run time after the first time the standard invokevirtual command for a method is executed. As stated above, the quick byte code instruction to quicken invocation of virtual methods is passed two operands, one representing the location of the virtual method in the vtable 139, the other representing the number of arguments of the virtual method. In prior implementations of Java, both operands of the quick byte code to invoke virtual methods are 8-bits long, and in general are equal in size. This allows for a total quickening of 256 methods, each having a total possible number of arguments of up to 256 or in general allows for the same number of methods as there are arguments.

In general a static method is not invoked on a receiver object 174 on the heap 170 as in the case of invoking virtual methods, but instead is called on a class itself. The byte code used to invoke a static method, requires an identification of the method called as an operand, which already contains information identifying the class. Typically this would include references to the constant pool 137 for the class of the method, a name for the method, and a descriptor which details the arguments and return types of the method. In Java, a standard invokestatic byte code command is used to invoke a static method. Additionally, in order to execute the invokestatic byte code, the operand stack 162 of the Java Stack 160 should contain any arguments the method requires.

Referring to FIG. 4, as with virtual methods, a Methodref entry can be referred to as the static method for invocation. Instead of an invokestatic byte code being passed the full name and type of the method being invoked, it is merely passed an index to a Methodref entry in the constant pool 137. At run time these constant pool method references are “resolved” when invoking static methods of the constant pool 137. This “method resolution” includes the steps of locating the method reference class, the name and type, and the descriptor. Once completed the resolution process provides enough information to name and identify the method being called.

Referring to FIG. 6, the following is an example of static method resolution through a class's constant pool 137. FIG. 6 shows extracts from a constant pool. As mentioned above, when an invokestatic byte code is to be executed, the arguments of the method should already be on the operand stack 162. When an invokestatic byte code is to be executed using a reference to an entry in the constant pool 137, for example “invokestatic #27”, constant pool entry 27 is located. Constant pool entry 27 is a Methodref constant: “Methodref class #10 and name-and-type #43”. A Methodref constant indicates other entries in the constant pool 137, one being an entry which points to a name for the class the invoked method is a member of (#10), and the other one being an entry which points to a constant which contains a name and descriptor of the method (#43). These must also be located in the constant pool 137. Entry 10 is “Class name #84”, and constant pool entry 84 contains a name for the class “java/lang/String”. In this way a class name is identified. Constant pool entry 43 (name-and-type) is “NameAndType name #99 descriptor #56”. These further constant pool entries are located, entry 99 containing a name of the method “valueOf”, and entry 56 containing a descriptor of the method “(Ljava/lang/Object;)Ljava/lang/String;” signifying an “Ljava/lang/Object” argument and an “Ljava/lang/String” return. Through resolution a Methodref “invokestatic #27” is resolved to “invokestatic java/lang/String/valueOf (Ljava/lang/Object;)Ljava/lang/String;.

After resolution, a procedure of dispatch typically occurs where the Java machine looks in the class to find the static method with the exact name and type determined through resolution of the operands to the invokestatic byte code. If the static method is present, the static method is located in the vtable 139 for the class the static method is a member of. Although static members can give the appearance of inheritance, strictly speaking, static methods cannot be overridden.

Referring to FIG. 4, in optimizing the process of static method invocation, there is a technique for “quickening” static method invocation. It is more efficient when a method is invoked, for the reference in the vtable 139 of that method to be known instead of performing the various look-up and comparison functions to resolve which exact method should be performed. At compile time however, the position of the method reference in the vtable 139, and the position of the class in the class table 135 are unknown. The system of FIG. 4 includes a quickening function 146 which quickens static methods as will now be discussed with reference to FIG. 7. Quickening static methods typically involves a one time standard invocation of a static method to be quickened causing resolution through the constant pool (or a resolution at class loading) at step 300, after which point in addition to the standard resolution procedure, the location of the static method in the vtable 139, and the location of the class in the class table 135 are found at step 302. Each one of the old invokestatic byte codes for invoking the static method to be quickened is replaced by a new invoking byte code called invokestatic_quick 204 (referred to above as a “quick” byte code, and part of the JVM Specification v.1) which uses as operands a) the index in the class table 135 of the class the static method belongs to, and b) the index in the vtable 139 which locates the specific method reference at step 304. The first and second operands avoid the need to perform the standard resolution procedure and the standard virtual dispatch process by respectively directly locating the appropriate class in the class table 135, and directly locating the appropriate method in the vtable 139. At class loading, the invokestatic byte codes can be replaced with invokestatic_quick byte codes or alternatively it can be done at run time after the first time the standard invokestatic byte code for a method is executed. As stated above, the quick byte code to quicken invocation of static methods is passed two operands, one representing the location of a class in the class table 135, the other representing the location of the static method reference in the vtable 139. In prior implementations of Java, both operands of the quick byte code instruction to invoke static methods are 8-bits long, and in general are equal in size. This allows for a total quickening of 256 methods, and a total of 256 accessible classes, or in general allows for the same number of methods as there are accessible classes.

In a multithreaded application in a Java-like machine or virtual machine, although each thread has its own stack, adapted to accommodate method frames, all threads share access to the heap 170 which is common to all threads of the multithreaded application. In order to enable controlled shared access to objects on the heap 170, locks are provided to allow controlled access to an object by only one thread at a time. This controlled form of access is called synchronization and is implemented using monitors. In the standard JM, a monitor is associated with every object. A thread acquires a monitor for an object by executing the monitorenter byte code when a reference to the object is on top of the stack 160. To release the monitor for that object the thread executes the monitorexit byte code on that object. The controlled access provided by the monitors is dependent upon the use of monitorenter and monitorexit byte codes. Only when a method observes synchronization restrictions, that is, properly uses monitorenter to attempt to gain control of a monitor for an object before accessing it, will that method be blocked when in fact another thread has control of the monitor for that object. An alternative to issuing monitorenter and monitorexit byte codes explicitly, the source code synchronized command may be used, which takes as an argument a reference to an object, and is followed by a block of code which the compiler automatically surrounds with a monitorenter and a monitorexit. Another procedure for ensuring synchronization is to declare a method as synchronized, which forces any thread attempting to use that method to obtain a lock on the object the method is invoked upon. Whenever the method is terminated or exited from for any reason, the monitor for the object is released. This procedure also avoids the need to execute monitorenter and monitorexit byte codes explicitly, and ensures all threads using the method at anytime observe the synchronization of the objects the method is called upon. A static method can also be declared as a synchronized method, in which case the object that is locked is the Class object corresponding to the class. In picoJava II™, once a method has been declared as synchronous, the code of the method is modified by the class loader 134. A set of byte codes are inserted at the beginning of the method's code. The inserted code has at the beginning: aload_{—}0, which is a local reference to the object; monitorenter, which lets the thread take control of the monitor; and JSR+6, which jumps to the original method code. In the method code all returns are replaced with exitsync which causes the subroutine to end and returns processing to the commands after JSR+6 which are: aload_{—}0, monitorexit, which releases the monitor, and return, which exits out of the method. The consequence of adding these instructions to the beginning of the method code, is that all subroutine jumps in the code must be offset by the number of additional bytes (which here is 8 bytes for the 6 instructions), as well as all references to the exception table which is shifted by that same amount. There is also the disadvantage of having to add byte codes to the code of every method which is declared synchronous, and there is always the danger that the code of the method itself may mismanage local variable 0 by way of an astore_{—}0, which could render a monitorexit ineffective and cause an unwanted permanent lock on the object. Also, in current known implementations of Java and Java-like languages, synchronous methods are not quickened.

In Java, invoking a method through an interface is possible with the use of the invokeinterface byte code. If all of the abstract public methods of an interface are implemented in a class, that class is said to implement the interface. An implementation of one of those methods is invoked using the invokeinterface byte code to invoke the method on a receiver object which is typically a variable of the interface type which an instance of a class implementing that interface has been assigned to. The operands of the invokeinterface byte code are the descriptor of the interface method and the number of stack words used as arguments to the method call, including the receiver itself.

As discussed above, quickening incorporating the use of a vtable in the context of inheritance is possible because if methods specific to a subclass override those of the superclass, the reference in the vtable to the superclass method is simply replaced by a reference to the subclass method, and that same position in each vtable applies to all derivative classes of the superclass. Due to the fact that an interface may be implemented by a multitude of different classes, there is no guarantee that the position of the reference to a single implementation in the vtable of one class will correspond to a position of the reference to another implementation in the vtable of another class since each class has its own set of specific methods. In essence a vtable cannot contain references to implementations of interface methods and still function as a vtable for use in quickening as described above.

### SUMMARY OF THE INVENTION

Various methods, byte code implementations, Java-like machines, preferably Java machines, are provided which enable the “quickening” of various instructions by various embodiments of the invention.

Several aspects of the invention relate to quickening of virtual invocations.

A first broad aspect of the invention provides a method of invoking a virtual method of a platform independent instruction set. The method involves executing a quick instruction to invoke a virtual method, the quick instruction being adapted to use a single operand representing the virtual method to be invoked, the quick instruction inherently adapted to invoke virtual methods only having a certain number of arguments. Preferably, the single operand representing the virtual method is an index to an entry in a vtable.

Another broad aspect of the invention provides a processor implemented method of invoking a virtual method of a platform independent instruction set. The processor implemented method executes a quick instruction to invoke a virtual method, the quick instruction being adapted to use a single operand representing the virtual method to be invoked, the quick instruction inherently locating a preset relative position on an operand stack to be treated as an object reference.

The preset relative position on the operand stack preferably corresponds to a relative position of a reference to the receiver object on the operand stack with respect to the position of a pointer to the operand stack when the quick instruction is initially executed.

A Java machine, Java-like machine, and byte code implementation are also provided in association with the above summarized methods.

Another broad aspect of the invention provides a method of quickening invocation of a method of a platform independent instruction set. The method of quickening invocation involves resolving a method producing a resolved method reference to a resolved method, the resolved method having a number of arguments and the resolved method reference having a position in a vtable; determining the number of arguments of the resolved method and the position of the resolved method reference in the vtable; and replacing a method invocation instruction with a new quick method invocation instruction to invoke the resolved method. The new quick method invocation instruction to invoke the resolved method on a receiver object is adapted to use a single operand representing a resolved method to be invoked. The new quick method invocation instruction inherently locates a preset relative position on an operand stack to be treated as an object reference.

The invention according to another broad aspect provides a method of method invocation. The method involves pushing an object reference having a type onto an operand stack; pushing n arguments onto the operand stack; executing a quick byte code having a single operand and operating to obtain the object reference from the operand stack by moving the stack pointer over the n arguments to a position on the operand stack containing the object reference; referring to a vtable entry identified by the single operand; and executing a version of the method referenced by the vtable entry consistent with the type of the object reference.

Several aspects of the invention relate to the quickening of static method invocations.

The invention according to one broad aspect provides a method of invoking a static method of a platform independent instruction set which might be for example a Java-like instruction set such as the Java instruction set or some other instruction set. The method involves executing a quick instruction to invoke a static method, the quick instruction being adapted to use a first operand representing a class the static method belongs to, and a second operand representing the static method to be invoked, wherein the bit-length of the first operand, and the bit-length of the second operand are not equal. Preferably, the bit-length of the first operand is longer than the bit-length of the second operand. For example, the bit-length of the first operand is 10-bits, and the bit-length of the second operand is 6-bits.

A Java-like machine and a Java machine, and byte code implementation are also provided which are adapted to implement the above introduced static invocation quickening method.

The invention according to another broad aspect provides a method of quickening invocation of a static method of a platform independent instruction set. The method of quickening invocation involves resolving a static method producing a resolved static method reference to a resolved static method, the resolved static method belonging to a class and the resolved static method reference having a position in a vtable; determining the class the resolved static method belongs to and the position of the resolved static method reference in the vtable; and replacing a static method invocation instruction with a new quick method invocation instruction to invoke the resolved static method. The new quick method invocation instruction to invoke resolved static methods is adapted to use a first operand representing the class the static method belongs to, and a second operand representing the static method to be invoked, wherein the bit-length of the first operand, and the bit-length of the second operand are not equal.

Further embodiments of the invention relate to quickening of synchronous method invocations.

A broad aspect of the invention provides a method of invoking a synchronous method of a platform independent instruction set. The method involves executing a quick instruction to invoke a synchronous method on a receiver object, the quick instruction being adapted to use a first operand, the first operand being the number of arguments of the synchronous method, and a second operand representing the synchronous method to be invoked, wherein the quick instruction inherently uses the first operand to obtain a pointer to a monitor of the receiver object, obtains control of the monitor of the receiver object, pushes the pointer of the monitor onto a standard stack frame, and causes execution of the synchronous method using the second operand. Preferably, the method further involves at class loading, replacing each *return instruction associated with the synchronous method with a respective new returnsync instruction which is adapted to atomically pop the pointer to the monitor off of the standard stack frame, and execute functionality equivalent to a monitorexit and a standard return.

In a preferred embodiment, a plurality of new returnsync instructions are provided, one for a return with no parameters, one for ireturn and freturn corresponding to 32-bit returns, one for lreturn and dreturn corresponding to 64-bit returns, and one for areturn corresponding to a 32-bit return.

Other embodiments of the invention provide a Java-like machine, preferably a Java machine, and byte code implementations adapted to implement the above introduced synchronous byte code quickening methods.

Another broad aspect of the invention provides a method of quickening invocation of a synchronous method of a platform independent instruction set. The method involves resolving a synchronous method producing a resolved synchronous method reference to a resolved synchronous method, the resolved synchronous method having a number of arguments and the resolved synchronous method reference having a position in a vtable; determining the number of arguments of the resolved synchronous method and the position of the resolved synchronous method reference in the vtable; and replacing a method invocation instruction with a new quick method invocation instruction to invoke the resolved synchronous method; replacing each return instruction of a variable type in the synchronous method code with a returnsync instruction, the returnsync instruction adapted to atomically pop a pointer to a monitor off of a standard stack frame, and execute functionality equivalent to a monitorexit and a standard return of the same variable type. The new quick method invocation instruction to invoke the resolved synchronous method on a receiver object, is adapted to use a first operand, the first operand being the number of arguments of the resolved synchronous method, and a second operand representing the resolved synchronous method to be invoked, the quick instruction inherently using the first operand to obtain a pointer to a monitor of the receiver object, obtaining control of the monitor of the receiver object, pushing the pointer of the monitor onto a standard stack frame, and causing execution of the resolved synchronous method using the second operand.

Other aspects of the invention relate to quickening of interface method invocations.

One broad aspect of the invention provides a method of invoking an interface method of a platform independent instruction set on a receiver object, the receiver object having a class, the class implementing a number of interfaces of a system. The method involves for each interface implemented by the class providing for the class an interface virtual table (Ivtable), providing for the class a master interface table (MItable) of references to the interface virtual tables corresponding to those interfaces the class implements, the interface virtual table comprising method reference entries of those methods of the interface the class implements; executing a quick instruction to invoke an interface method on a receiver object, the quick instruction being adapted to use a first operand, the first operand being a number of arguments of the interface method, a second operand representing the interface the interface method is a member of, and a third operand representing the interface method to be invoked, the quick instruction inherently adapted to use the first operand to identify the class, use the second operand to identify the interface, and use the third operand to locate the specific interface method. Preferably, the second operand represents the interface the interface method is a member of is an index to an entry in an MItable. Preferably, the third operand represents the interface method to be invoked is an index to an entry in an Ivtable.

Other embodiments of the invention provide a Java-like machine, preferably a Java machine, and byte code implementations adapted to implement the above introduced static method invocation quickening methods.

Another broad aspect of the invention provides a method of quickening invocation of an interface method of a platform independent instruction set, the interface method being a member of an interface. The method involves resolving an interface method producing a resolved interface method reference to a resolved interface method, the resolved interface method having a number of arguments and the resolved interface method reference having a position in an interface virtual table (Ivtable); determining the position of a reference to the Ivtable in a master interface table (MItable) of a class, determining the number of arguments of the resolved interface method and determining the position of the resolved interface method reference in the Ivtable; and replacing a method invocation instruction with a new quick method invocation instruction to invoke the resolved interface method. The new quick method invocation instruction to invoke the resolved interface method on a receiver object, is adapted to use a first operand, the first operand being the number of arguments of the resolved interface method, a second operand representing the interface the resolved interface method is a member of, and a third operand representing the resolved interface method to be invoked, the quick instruction inherently using the first operand to identify the class, using the second operand to identify the interface, and using the third operand to locate the specific interface method.

Other embodiments of the invention, in providing for the class a master interface table, provide for a system interface table of all interfaces of a system and provide for using the system interface table as a template for creating the master interface table.

Other embodiments of the invention, in providing for the class a master interface table, provide for eliding NULL entries of the master interface table up to a first non-NULL entry, and replacing said elided entries with a count of the number of entries elided.

### BRIEF DESCRIPTION OF THE DRAWINGS

The invention will now be described in greater detail with reference to the accompanying diagrams, in which:

FIG. 1 is a table showing entries in a constant pool to illustrate method resolution;

FIG. 2 is a flowchart depicting the steps for quickening of virtual method invocation;

FIG. 3 is a flowchart depicting the steps of one embodiment of the invention for providing quickening of virtual method invocation;

FIG. 4 is a system block diagram of a Java machine including known quick byte codes;

FIG. 5 is system block diagram of a Java machine provided by an embodiment of the invention which provides for quickened invocation of virtual methods;

FIG. 6 is a table showing entries in a constant pool to illustrate static method resolution;

FIG. 7 is a flowchart depicting the steps for quickening of static method invocation;

FIG. 8 is a flowchart depicting the steps of one embodiment of the invention for providing quickening of static method invocation;

FIG. 9 is system block diagram of a Java machine provided by an embodiment of the invention which provides for quickened invocation of static methods;

FIG. 10 is system block diagram of a Java machine provided by an embodiment of the invention which provides for quickened invocation of synchronous methods;

FIG. 11 is a flowchart depicting the steps for one embodiment of the invention for providing quickening of synchronous method invocation;

FIG. 12 is a flowchart depicting the run-time steps of a single method invocation for one embodiment of the invention for providing quickening of synchronous method invocation;

FIG. 13 is system block diagram of a Java machine provided by an embodiment of the invention which provides for quickened invocation of interface methods;

FIG. 14 is a block diagram of the relationship between the system interface table, the MItable and the Ivtable provided by an embodiment of the invention which provides for quickened invocation of interface methods; and

FIG. 15 is a flowchart depicting the steps for quickening of interface method invocation.

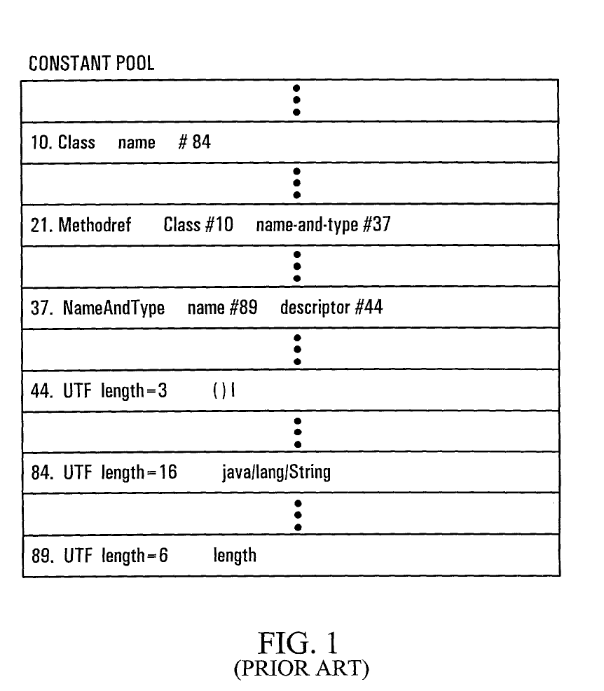

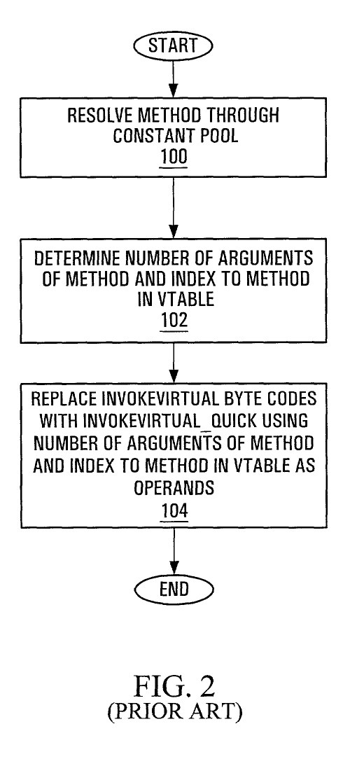

### DETAILED DESCRIPTION OF THE PREFERRED EMBODIMENTS

For the purpose of this description, the term “byte code” will be used to refer both to an opcode consisting of a code understood by a processor or virtual machine and to the underlying functionality executed by a processor or virtual machine in processing the opcode, the particular meaning in a given use being dictated by context. The term “instruction” will be used to refer to a byte code together with any operands of the byte code.

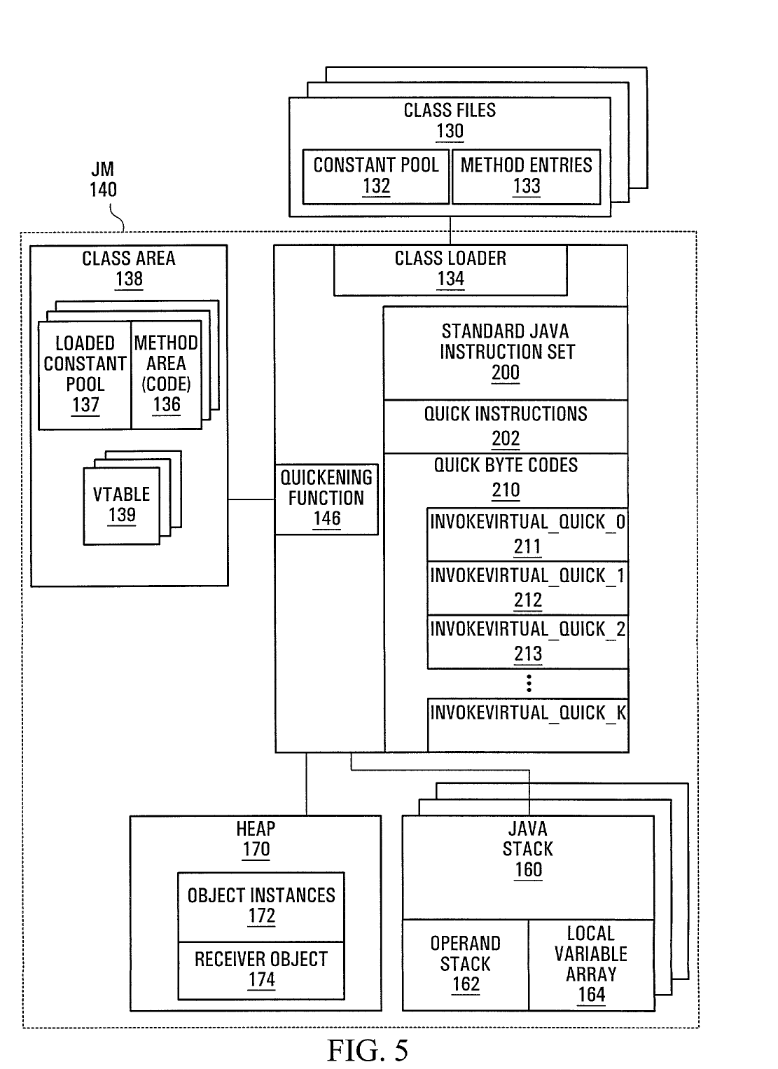

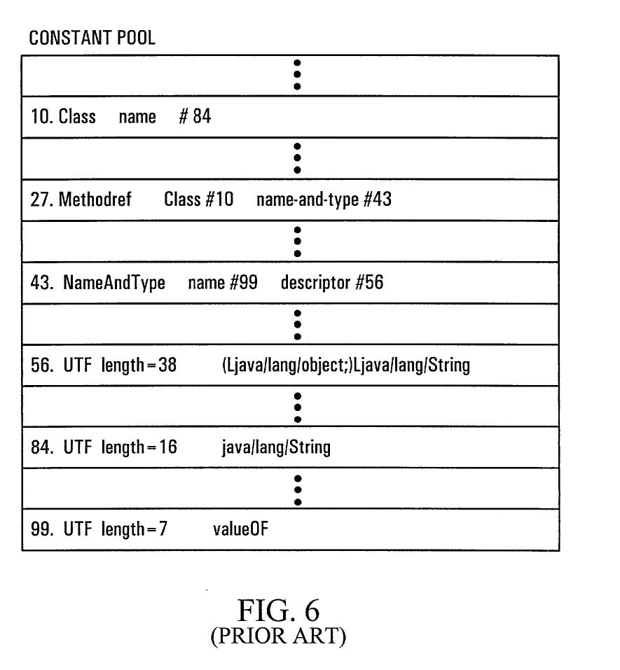

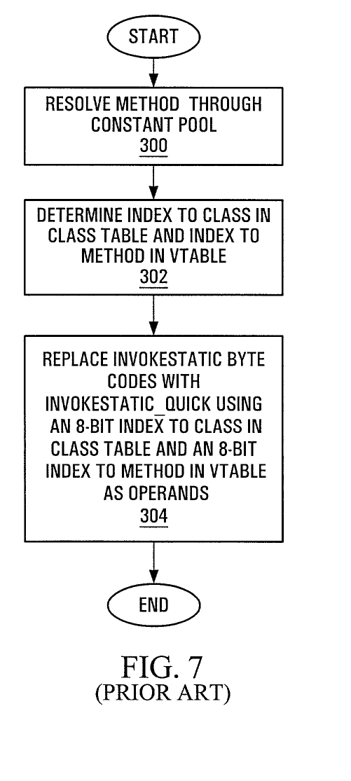

Referring now to FIG. 5, a preferred embodiment of the invention is described. Typically, a standard Java method uses relatively few arguments, and the even allocation by conventional quickening methods between the number of methods accessible and the number of arguments per method is inefficient as there may be more than 256 methods which could benefit from being quickened. One preferred embodiment of the invention provides a system and a method to more efficiently allocate the 16-bits used in quickened invocations of virtual methods. A virtual method quickening invocation byte code is provided which inherently functions for certain numbers of method arguments by virtue of providing functionality coded into the byte code itself. Advantageously, the SP+nargs arithmetic step required in conventional quickened invocations is avoided, the stack memory need not be flushed and parameters forwarded between caches, and the quickening logic may be simplified in that the range of the method index does not need to be tested to verify that it is appropriate.

Instead of there being only a single byte code for invoking virtual methods, unused byte codes are used to create a set of K+1 invokevirtual_quick byte codes 210, which for convenience will be referred to herein as invokevirtual_quick_n, where n =0 to K. Instead of being passed two operands 8-bits in length each, invokevirtual_quick_n is passed a single operand 16-bits in length pointing to an index in the vtable 139. The index “n” identifies an invokevirtual_quick_n byte code which has been designed to operate in such a way as to invoke a virtual method having a specific number of arguments. In the preferred naming convention n=0 for the byte code designed to work with methods having no arguments, namely invokevirtual_quick_{—}0 211, n=1 for the byte code designed to work with methods having one argument, namely invokevirtual_quick_{—}1 1 212, n=2 for the byte code designed to work with methods having two arguments, namely invokevirtual_quick_{—}2 213, the preferred naming convention in general having n identifying a byte code designed to invoke methods having n arguments. Irrespective of the naming convention actually used, each invokevirtual_quick_n byte code is designed to operate with methods having a specific number of arguments. The result of having all 16-bits assigned to the index of the virtual method, is that instead of only 256 possible methods, the invokevirtual_quick_n byte code could reference up to 65536 possible methods in the vtable 139.

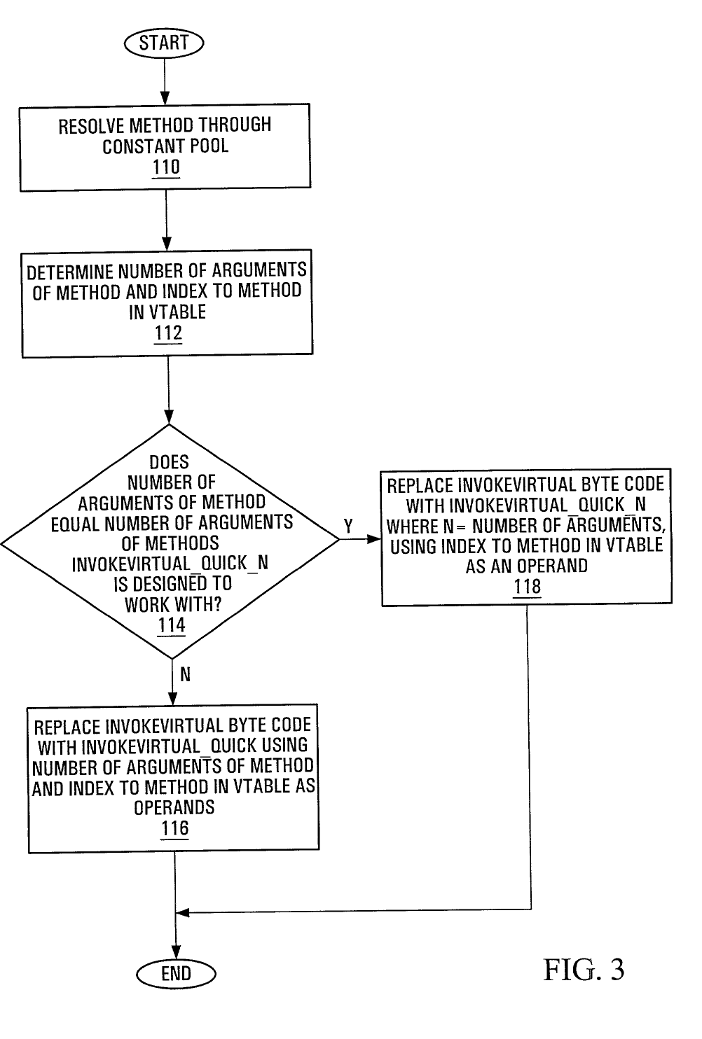

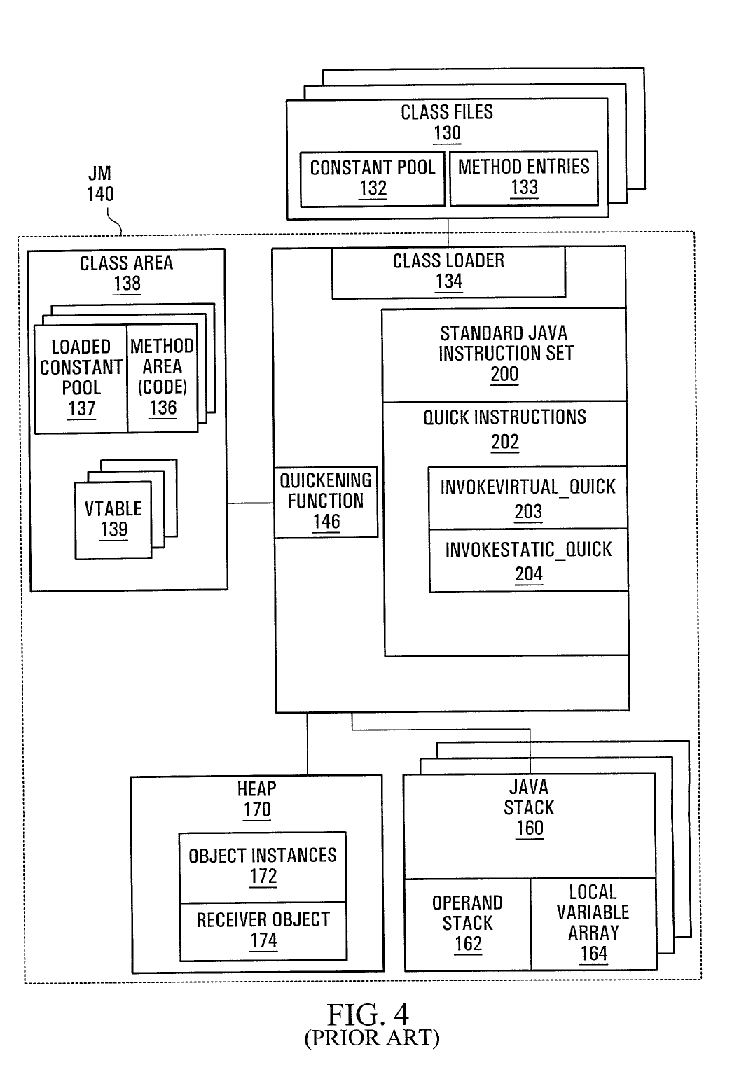

Referring now to FIG. 3, which is a flowchart depicting the steps for quickening of virtual methods for a preferred embodiment of the present invention, a one time standard invocation of a method upon an object instantiating a particular class is performed causing resolution through the constant pool (or alternatively resolution occurs at class loading) 110, after which point the number of arguments of the method and the location of the method in the vtable 139 are found at step 112. At step 114 the number of method arguments is compared to the specific number of arguments the invokevirtual_quick_n byte codes are designed to work with. If the number of method arguments is not among those the invokevirtual_quick_n byte codes are designed to work with, each one of the old standard invokevirtual byte codes invoking the method to be quickened is replaced by an invokevirtual_quick byte code, and using as operands a) the index in the vtable 139 which locates the specific method reference, and b) the number of arguments the method requires 116. This allows for standard quickening when required and is only possible if the index into the vtable 139 is within the range allowed by the 8-bit operand. If this is not the case, the method invocation cannot be quickened. If the number of method arguments is among those the invokevirtual_quick_n byte codes are designed to work with, then in step 118 each one of the standard invokevirtual byte codes is replaced by the invokevirtual_quick_n designed to work with that specific number of method arguments, which uses as its single operand, the index in the vtable 139 which locates the specific method reference.

The above description is but one preferred embodiment of the invention which provides for quickened invocation of virtual methods. It should be understood that although the preferred embodiment uses a naming convention that implies a contiguous set of K+1 invokevirtual_quick_n byte codes, the invokevirtual_quick_n instructions in the set of K+1 byte codes may be in any particular order, and may be designed for methods having widely differing numbers of arguments. For example, an alternative embodiment of the invention provides a set of invokevirtual_quick_n byte codes for a non-contiguous set consisting of the contiguous set (0, . . . ,i} and j, (n =0, . . . ,i,j) where j>i. For methods having a number of arguments corresponding to members of the contiguous set, that is between 0 and i arguments, the corresponding invokevirtual_quick_n byte code is used for that number of arguments. In the case that the number of arguments of the method is greater than i and less than or equal to j, invokevirtual_quick_j is used, along with the compiler padding the stack with the appropriate number of dummy entries so that when the quick byte code is executed the object reference is properly located on the stack by the invokevirtual_quick_j byte code. A specific example of such a set of quick byte codes is where n=0,1,2,3, and 8, wherein for invoking methods requiring the less frequent argument counts of 4,5,6,7, and 8, invokevirtual_quick_{—}8 is used, with the appropriate number of dummy entries on the stack so that when the quick byte code invokevirtual_quick_{—}8 is executed the object reference is properly located on the stack.

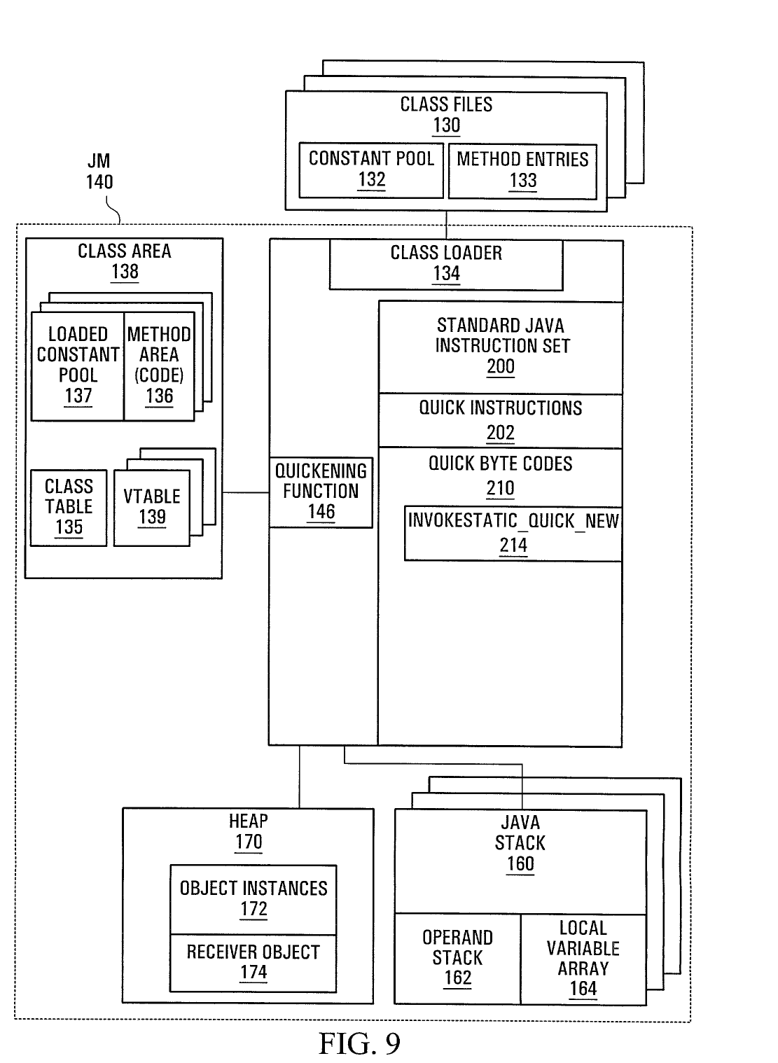

Referring now to FIG. 9, a preferred embodiment of the invention which provides quickened invocation of static methods is described. Typically, a standard Java application will involve over 200 classes before the Java “world” is turned on and the typical class will have 20-25 static method references, and the even allocation of conventional quickening methods between the number of accessible classes and accessible static methods is inefficient as there may be more than 256 classes which could benefit from member static methods being quickened. One preferred embodiment of the invention provides a system and a method to more efficiently allocate the 16-bits used in quickened invocations of static methods. Instead of there being an even allocation of the 16-bits between the class index and the vtable index, the invention uses an unused byte code to create an invokestatic_quick_new 214 command, which instead of being passed two operands 8-bits in length each, is passed a first operand (16−m) bits in length, and a second operand m bits in length, where m is a positive integer less than 16, the first operand representing the location of the class in the class table 135, and the second operand representing the location of the static quickened method in the vtable 139. In the preferred embodiment, m is less than 8 and in an exemplary embodiment m is equal to 6. In the exemplary embodiment the number of accessible classes is 2^{(16-m)}=2¹⁰=1024, while the number of possible method references accessible in the vtable 139 is 2^{m}=2⁶=64.

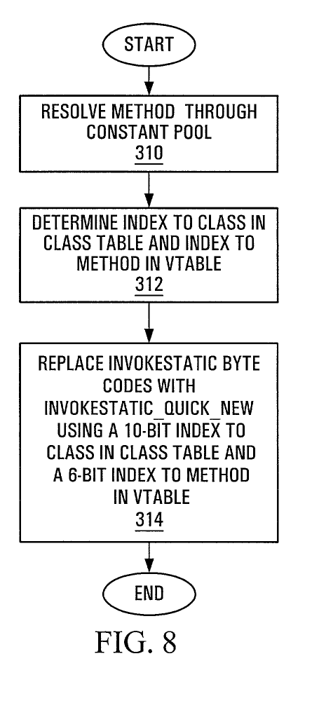

Referring now to FIG. 8, which is a flowchart depicting the steps for quickening of static methods for a preferred embodiment of the present invention, a one time standard invocation of a static method is performed causing resolution through the constant pool (or alternatively resolution occurs at class loading) 310, after which point the class of the static method in the class table 135 and the location of the static method in the vtable 139 are found at step 312. At step 314 each one of the standard invokestatic byte codes are replaced by an invokestatic_quick_new 214 byte code of the present invention, which uses as its operands a 10-bit index to the class in the class table 135 that the static method belongs to, and a 6-bit index to the vtable 139 which locates the specific static method reference.

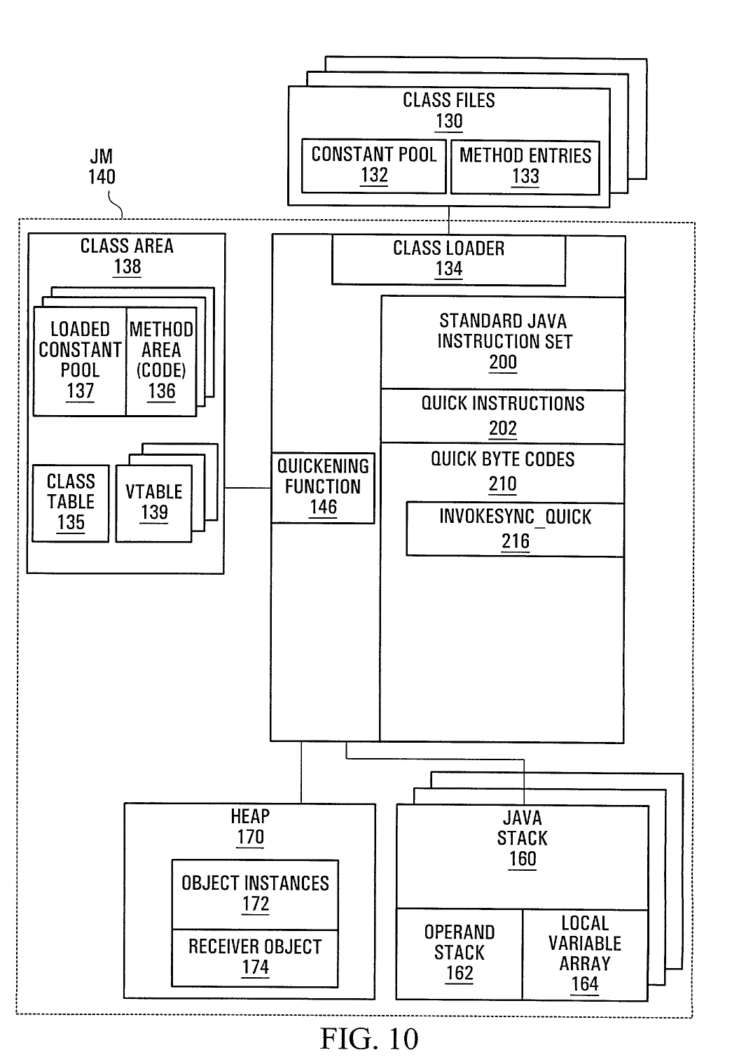

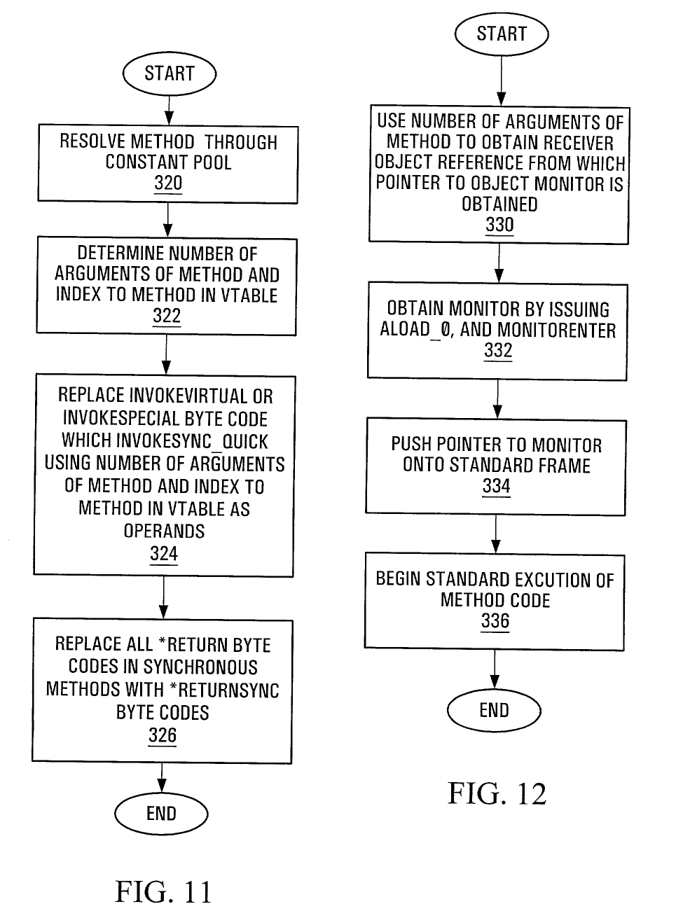

Referring now to FIG. 11, a preferred embodiment of the invention which provides quickened invocation of synchronous methods is described. In optimizing the process of synchronous method invocation, the standard technique for “quickening” virtual method invocation is used along with other improvements to the way synchronization is handled. As with quickening virtual methods, quickening synchronized methods typically involves a one time standard invocation of a method to be quickened causing resolution through the constant pool (or a resolution at class loading) at step 320, after which point in addition to the standard resolution procedure, the number of arguments of the method and the location of the method in the vtable 139 are found at step 322. Referring also to FIG. 10, each one of the old invokevirtual byte codes used to invoke synchronous methods to be quickened is replaced by a new invoking “quick” byte code called invokesync_quick 216. Invokesync_quick 216 can also replace invokespecial byte codes used to invoke synchronous methods as well. The invokesync_quick 216 byte code uses as operands a) the index in the vtable 139 which locates the specific method reference, and b) the number of arguments the method requires (step 324). At class loading, the invokevirtual or invokespecial byte codes which invoke synchronous methods can be replaced with invokesync_quick 216 byte codes or alternatively it can be done at run time after the first time the standard invoking command for a synchronous method is executed. One embodiment of the invention is such that both operands of the quick byte code instruction to invoke synchronous methods are 8-bits long, however they may be allocated more efficiently if desired. In order to properly exit from a method invoked by the invokesync_quick 216 command, all returns in the synchronized method must be replaced with returnsync of the same type. For example “ireturn” must be replaced with “ireturnsync”, “lreturn” must be replaced with “lreturn” sync, and in general “*return” must be replaced with “*returnsyncff where * represents any variable type, shown in step 326. The *returnsync commands have functionality to pop the monitor off the standard frame, and functionality equivalent to a monitorexit and a standard *return. In a preferred embodiment of the invention, rather than providing a separate returnsync command for each type of return, functionality described in copending commonly assigned U.S. application Ser. No. 09/746,016 hereby incorporated by reference in its entirety, may be used to reduce the number of returnsync byte codes which need to be implemented. More particularly, rather than implementing areturnsync in respect of areturn, ireturnsync in respect of ireturn, freturnsync in respect of freturn, lreturnsync in respect of lreturn, dreturnsync in respect of dreturn, and returnsync in respect of return (for functions with no return parameter), a single byte code can be used for both ireturnsync and freturnsync since they are functionally equivalent during runtime, and a single byte code can be used for both lreturnsync and dreturnsync since they are functionally equivalent at runtime.

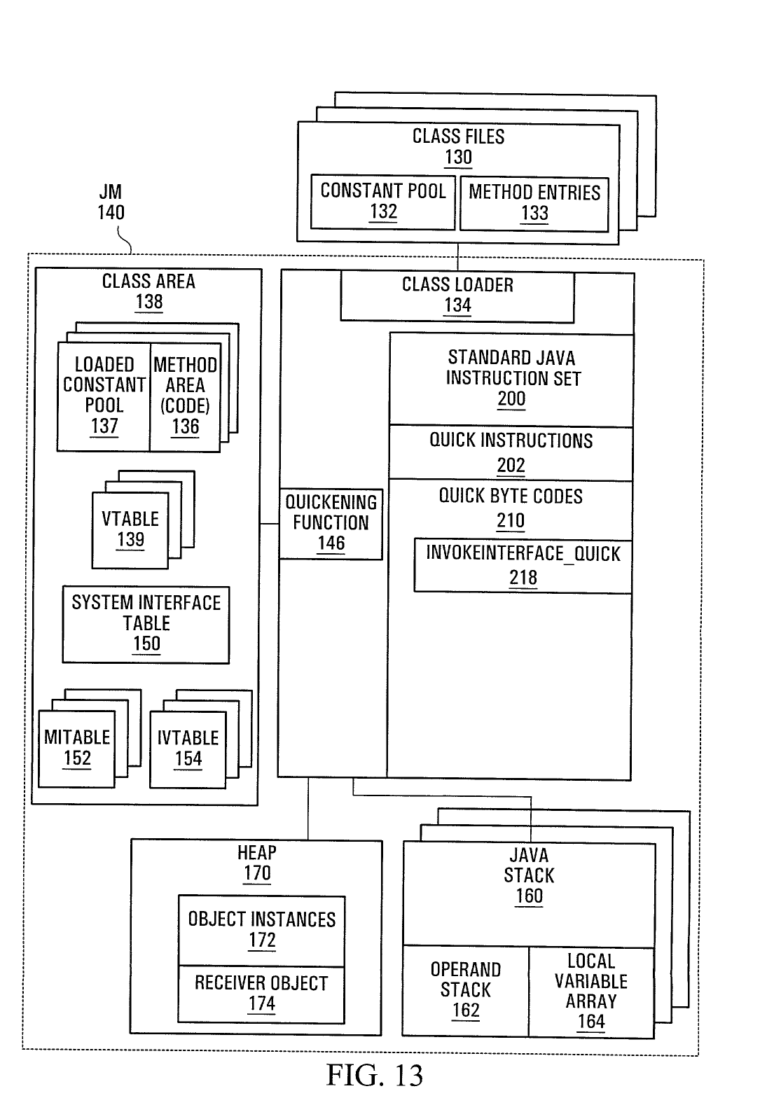

Referring now to FIG. 12, the run-time steps of an embodiment of the invention providing for a quickened method invocation for synchronous methods is described. The number of arguments of the method is used to obtain the object reference through which a pointer to the monitor of the object can be obtained in step 330. Once the pointer to the monitor has been found, the monitor itself is obtained, by atomically executing the equivalent of an aload_{—}0, and a monitorenter in step 332. The monitor pointer is then pushed onto the standard frame in step 334. The standard execution of the method code itself is then begun in step 336. Invokesync_quick 216, having pushed the monitor pointer on the stack, works in conjunction with the *returnsync function which pops the monitor pointer off of the stack without having to refer to the object and find the monitor again. The use of the invokesync_quick 216 byte code avoids the need to shift all subroutine jumpers, and the need to shift all entries in the exception table because no code is inserted into the method code itself. It also does not increase the size of all synchronized methods. It also avoids the problem of the method code mismanaging local variable 0 causing a permanent lock, since the *returnsync pops the pointer to the monitor off the frame instead of loading it using aload_{—}0. The *returnsync also goes directly to the monitor in the object and not the object itself since the monitor pointer was pushed by the invokesync_quick 216 byte code onto the standard frame. Advantageously, the invocations of synchronized methods has also been quickened by using the number of arguments of the method to find the object reference, and using the index to the method in the vtable 139.

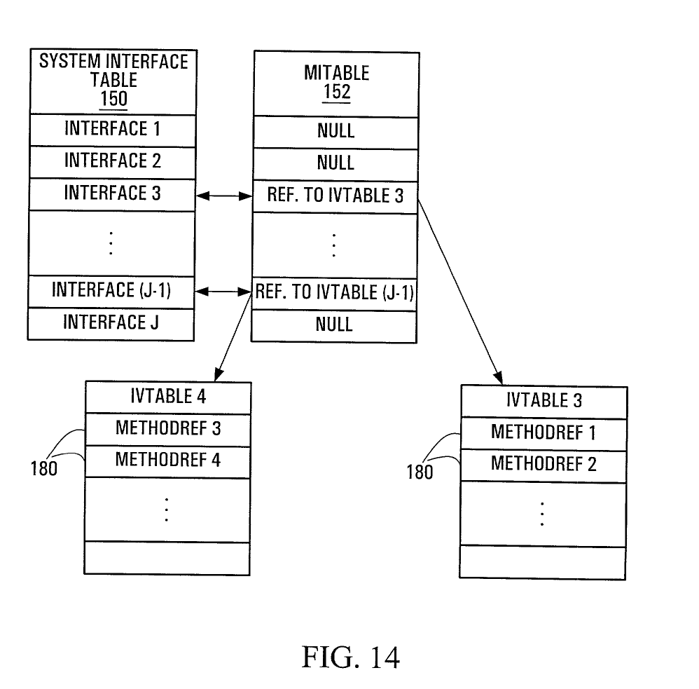

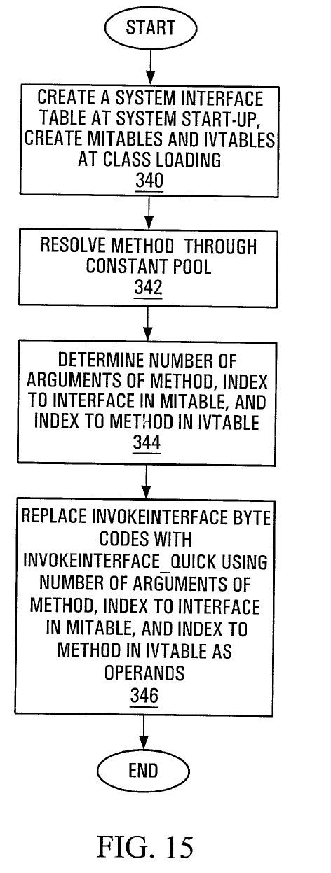

Referring now to FIG. 13, a preferred embodiment of the invention which provides quickened invocation of interface methods is described. The problem that interfaces cannot strictly use vtables for method quickening is solved by introducing a system interface table 150, a master interface table (MItable) 152 for each class, and an interface virtual table (Ivtable) 154 for each interface implemented by a class. Referring now to FIG. 14, the relationships between the system interface table, the MItables and the Ivtables will now be described. For an application containing a total of J interfaces, the system interface table 150, created at system start-up, contains a list of all interfaces 1 to J. For each class, the MItable 152, created at class loading, contains a list of references to the Ivtables 154, also created at class loading, corresponding to the interfaces implemented by the class, each of which in turn contain method references 180 to the class implementations of the interface methods. In one embodiment of the invention, the MItable 152 for a class contains references to the Ivtables 154 of class implementations of an interface at positions corresponding to the positions of those interface entries in the system interface table 150. The rest of the positions in the MItable 152 of the class are NULL indicating that the class does not implement the interfaces corresponding to those positions in the system interface table 150. In this manner the system interface table 150 forms a template for generating the MItables 152. In another embodiment, the MItable 152 is elided up to a first non-NULL entry, replacing the NULL entries with a single entry containing a count of the number of entries which have been elided. The Ivtable 154 referenced by an entry in the MItable 152 contains a list of the method references 180 of that interface which the class implements, and is similar to a vtable 139 in that respect. At class loading, when an interface is first loaded by a class, a template for subsequent Ivtables 154 is created. If an Ivtable 154 for a subsequent class is created after the first class has loaded the interface, that Ivtable 154 for the subsequent class is created from the template of the first class to maintain method offsets. Referring to FIG. 14, the example MItable 152 of a class indicates that the class does not implement interface 1, interface 2, or interface J, but does implement interface 3 and interface(J−1). The entry in the position indicating that the class implements interface 3 is a reference to the Ivtable 154 of the class for interface 3, Ivtable 3. The Ivtable 154 contains method references 180 to the actual class implementations of the interface 3 methods, for example Methodref 1, and Methodref 2. Similarly, the entry in the position indicating that the class implements interface(J−1) is a reference to the Ivtable 154 of the class for interface(J−1), Ivtable 4, which contains method references 180 to the actual class implementations of the interface(J−1) methods, Methodref 3, and Methodref 4. As was the case for virtual and static methods, quickening method invocation for interface methods is more efficient than standard method resolution and dispatch processes. The system interface table 150 is created at system start-up and the MItables 152 for each class is created at class loading because the dimensions of these tables is fixed once the number of interfaces and methods they comprise are known, as well as which interfaces each class implements. The position in an Ivtable 154 of a reference to a method implementation by a class of an interface method, however, is unknown at compile time. The system of FIG. 13 includes a quickening function which quickens interface methods as will be discussed with reference to FIG. 15, which is a flowchart depicting the steps for quickening of interface methods for a preferred embodiment of the present invention. At step 340, a system interface table is created at system start-up, and the MItables and Ivtables are created at class loading. Quickening an implementation of an interface method typically involves a one time standard invocation of the method to be quickened causing resolution through the constant pool (or a resolution at class loading) at step 342, after which point the number of arguments of the interface method, the index to the interface in the MItable which corresponds to the position of a reference to an Ivtable corresponding to that interface, and the location of the method implementation in the Ivtable, are found at step 344. At step 346, each one of the old invokeinterface byte codes used to invoke interface methods to be quickened is replaced by a new invoking “quick” byte code called invokeinterface_quick 218, which uses as operands a) the size of the stack (which here corresponds to the number of arguments of the method, and does not count the object reference on the stack itself), b) the index in the MItable 152 where the reference to the Ivtable 154 for the implemented interface is located, and c) the index in the Ivtable 154 which locates the specific method implementation reference. The first operand is used by invokeinterface_quick 218 to locate the receiver object reference on the operand stack 162 to identify its class in order to locate the MItable 152 of that class. The second and third operands avoid the need to perform the standard resolution procedure and the standard virtual dispatch process, by directly locating the appropriate Ivtable 154 in the MItable 152 and locating the specific method reference in the Ivtable 154. At class loading, the invokeinterface byte codes can be replaced with invokeinterface_quick 218 byte codes or alternatively it can be done at run time after the first time the standard invokeinterface command for an interface method is executed. In the preferred embodiment each of these operands is 8-bits in length, totalling 32-bits for a single invokeinterface_quick 218 call.

It should be understood that although in the above description the quickening of method invocation occurs in a Java environment running on a JM 140 or JVM, quickening of method invocation is contemplated by the invention for any Java-like language, and more generally for any platform independent language. It should also be understood that although reference is made to quick Java byte codes, in general non-Java, arbitrary bit-length instructions for quickening method invocation is contemplated by the invention. It further should be understood that the foregoing description equally applies to systems implemented in hardware, hardware and software, and software alone. If any software implementation is involved, the description equally applies to trapped instructions as it does to the Java byte code instructions explicitly referred to. Without limiting the generality of the foregoing, the invention contemplates environments and software instructions similar in functionality to that described including but not limited to the following: Common Language Interchange (CLI), Intermediate Language (IL) and Common Language Run-time (CLR) environments and C# programming language as part of the .NET and .NET compact framework, available from Microsoft Corporation Redmond, Wash.; Binary Run-time Environment for Wireless (BREW) from Qualcom Inc., San Diego; or the MicrochaiVM environment from Hewlett Packard Corporation, Palo Alto, Calif.

Numerous modifications and variations of the present invention are possible in light of the above teachings. It is therefore to be understood that within the scope of the appended claims, the invention may be practised otherwise than as specifically described herein.

We claim:

1. A method of invoking a virtual method of a platform independent instruction set, the method comprising:
executing a quick instruction to invoke a virtual method, the quick instruction being adapted to use a single operand representing the virtual method to be invoked, the quick instruction inherently adapted to invoke virtual methods only having a certain number of arguments.

2. The method according to claim 1 wherein the single operand representing the virtual method is an index to an entry in a vtable.

3. The method according to claim 1 wherein the platform independent instruction set is a Java-like instruction set.

4. The method according to claim 1 wherein the platform independent instruction set is a Java instruction set.

5. A processor implemented method of invoking a virtual method of a platform independent instruction set, the processor implemented method comprising:
executing a quick instruction to invoke a virtual method, the quick instruction being adapted to use a single operand representing the virtual method to be invoked, the quick instruction inherently locating a preset relative position on an operand stack to be treated as an object reference.

6. The method according to claim 5 wherein the preset relative position on the operand stack corresponds to a relative position of a reference to the receiver object on the operand stack with respect to the position of a pointer to the operand stack when the quick instruction is initially executed.

7. The method according to claim 5 wherein the preset relative position on the operand stack is a function of the number of arguments of the virtual method.

8. The method according to claim 5 wherein the single operand representing the virtual method is an index to an entry in a vtable.

9. The method according to claim 5 wherein the platform independent instruction set is a Java-like instruction set.

10. A Java-like machine adapted to execute a quick instruction to invoke a virtual method, the quick instruction being adapted to use a single operand representing the virtual method to be invoked, the quick instruction inherently locating a preset relative position on an operand stack to be treated as an object reference.

11. A Java Machine adapted to execute a quick instruction to invoke a virtual method, the quick instruction being adapted to use a single operand representing the virtual method to be invoked, the quick instruction inherently locating a preset relative position on an operand stack to be treated as an object reference.

12. The Java Machine of claim 11 wherein the preset relative position on the operand stack corresponds to a relative position of a reference to the receiver object on the operand stack with respect to the position of a pointer to the operand stack when the quick instruction is initially executed.

13. The Java Machine of claim 11 wherein the preset relative position on the operand stack is a function of the number of arguments of the virtual method.

14. The Java Machine of claim 11 wherein the single operand representing the virtual method is an index to an entry in a vtable.

15. A byte code implementation comprising a quick byte code adapted to invoke a virtual method, the quick byte code being adapted to use a single operand representing the virtual method to be invoked, the quick byte code inherently locating a preset relative position on an operand stack to be treated as an object reference.

16. The byte code implementation of claim 15 wherein the preset relative position on the operand stack corresponds to a relative position of a reference to the receiver object on the operand stack with respect to the position of a pointer to the operand stack when the quick byte code is initially executed.

17. The byte code implementation of claim 15 wherein the preset relative position on the operand stack is a function of the number of arguments of the virtual method.

18. The byte code implementation of claim 15 wherein the single operand representing the virtual method is an index to an entry in a vtable.

19. A method of quickening invocation of a method of a platform independent instruction set, the method of quickening invocation comprising:
resolving a method producing a resolved method reference to a resolved method, the resolved method having a number of arguments and the resolved method reference having a position in a vtable;
determining the number of arguments of the resolved method and the position of the resolved method reference in the vtable; and
replacing a method invocation instruction with a new quick method invocation instruction to invoke the resolved method;
wherein the new quick method invocation instruction to invoke the resolved method on a receiver object, is adapted to use a single operand representing a resolved method to be invoked, the new quick method invocation instruction inherently locating a preset relative position on an operand stack to be treated as an object reference.

20. A method according to claim 19 wherein the preset relative position on the operand stack corresponds to a relative position of a reference to the receiver object on the operand stack with respect to the position of a pointer to the operand stack when the new quick method invocation instruction is initially executed.

21. The method according to claim 19 wherein the preset relative position on the operand stack is a function of the number of arguments of the virtual method.

22. A method according to claim 19 wherein the single operand representing the resolved method is an index to an entry in a vtable.

23. A method according to claim 19 wherein the platform independent instruction set is a Java-like instruction set.

24. A method of method invocation comprising:
pushing an object reference having a type onto an operand stack;
pushing n arguments onto the operand stack;
executing a quick byte code having a single operand and operating to obtain the object reference from the operand stack by moving the stack pointer over the n arguments to a position on the operand stack containing the object reference;
referring to a vtable entry identified by the single operand; and
executing a version of the method referenced by the vtable entry consistent with the type of the object reference.

25. A method of invoking a static method of a platform independent instruction set, the method comprising:
executing a quick instruction to invoke a static method, the quick instruction being adapted to use a first operand representing a class the static method belongs to, and a second operand representing the static method to be invoked, wherein the bit-length of the first operand, and the bit-length of the second operand are not equal.

26. The method according to claim 25 wherein the bit-length of the first operand is longer than the bit-length of the second operand.

27. The method according to claim 26 wherein the bit-length of the first operand is 10-bits, and the bit-length of the second operand is 6-bits.

28. The method according to claim 25 wherein the platform independent instruction set is a Java-like instruction set.

29. The method according to claim 25 wherein the platform independent instruction set is a Java instruction set.

30. A processor implemented method of invoking a static method of a platform independent instruction set, the processor implemented method comprising:
executing a quick instruction to invoke a static method, the quick instruction being adapted to use a first operand representing a class the static method belongs to, and a second operand representing the static method to be invoked, wherein the bit-length of the first operand, and the bit-length of the second operand are not equal.

31. The method according to claim 30 wherein the bit-length of the first operand is longer than the bit-length of the second operand.

32. The method according to claim 31 wherein the bit-length of the first operand is 10-bits, and the bit-length of the second operand is 6-bits.

33. The method according to claim 30 wherein the first operand representing the class the static method belongs to is an index to an entry in a class table, and the second operand representing the static method to be invoked is an index to an entry in a vtable.

34. The method according to claim 30 wherein the platform independent instruction set is a Java-like instruction set.

35. A Java-like machine adapted to execute a quick instruction to invoke a static method, the quick instruction being adapted to use a first operand representing the class the static method belongs to, and a second operand representing the static method to be invoked, wherein the bit-length of the first operand, and the bit-length of the second operand are not equal.

36. A Java Machine adapted to execute a quick instruction to invoke a static method, the quick instruction being adapted to use a first operand representing a class the static method belongs to, and a second operand representing the static method to be invoked, wherein the bit-length of the first operand, and the bit-length of the second operand are not equal.

37. The Java Machine of claim 36 wherein the first operand representing the class the static method belongs to is an index to an entry in a class table, and the second operand representing the static method to be invoked is an index to an entry in a vtable.

38. A byte code implementation comprising a quick byte code adapted to invoke a static method, the quick byte code being adapted to use a first operand representing a class the static method belongs to, and a second operand representing the static method to be invoked, wherein the bit-length of the first operand, and the bit-length of the second operand are not equal.

39. The byte code implementation of claim 38 wherein the first operand representing the class the static method belongs to is an index to an entry in a class table, and the second operand representing the static method to be invoked is an index to an entry in a vtable.

40. A method of quickening invocation of a static method of a platform independent instruction set, the method of quickening invocation comprising:
resolving a static method producing a resolved static method reference to a resolved static method, the resolved static method belonging to a class and the resolved static method reference having a position in a vtable;
determining a class the resolved static method belongs to and a position of the resolved static method reference in the vtable; and
replacing a static method invocation instruction with a new quick method invocation instruction to invoke the resolved static method;
wherein the new quick method invocation instruction to invoke resolved static methods is adapted to use a first operand representing the class the static method belongs to, and a second operand representing the static method to be invoked, wherein the bit-length of the first operand, and the bit-length of the second operand are not equal.

41. The method according to claim 40 wherein the bit-length of the first operand is longer than the bit-length of the second operand.

42. The method according to claim 41 wherein the bit-length of the first operand is 10-bits, and the bit-length of the second operand is 6-bits.

43. The method according to claim 40 wherein the first operand representing the class the static method belongs to is an index to an entry in a class table, and the second operand representing the static method to be invoked is an index to an entry in a vtable.

44. A method according to claim 40 wherein the platform independent instruction set is a Java-like instruction set.

45. A method of invoking a synchronous method of a platform independent instruction set, the method comprising:
executing a quick instruction to invoke a synchronous method on a receiver object, the quick instruction being adapted to use a first operand, the first operand being the number of arguments of the synchronous method, and a second operand representing the synchronous method to be invoked, wherein the quick instruction inherently uses the first operand to obtain a pointer to a monitor of the receiver object, obtains control of the monitor of the receiver object, pushes the pointer of the monitor onto a standard stack frame, and causes execution of the synchronous method using the second operand.

46. The method according to claim 45 further comprising:
at class loading, replacing each *return instruction associated with the synchronous method with a respective new returnsync instruction which is adapted to atomically pop the pointer to the monitor off of the standard stack frame, and execute functionality equivalent to a monitorexit and a standard return.

47. The method according to claim 46 wherein
a plurality of new returnsync instructions are provided, one for a return with no parameters, one for ireturn and freturn corresponding to 32-bit returns, one for lreturn and dreturn corresponding to 64-bit returns, and one for areturn corresponding to a 32-bit return.

48. The method according to claim 46 wherein the second operand representing the synchronous method is an index to an entry in a vtable.

49. The method according to claim 46 wherein the platform independent instruction set is a Java-like instruction set.

50. The method according to claim 46 wherein the platform independent instruction set is a Java instruction set.

51. A Java-like machine adapted to execute a quick instruction to invoke a synchronous method, the Java-like machine being adapted to replace each return instruction with a corresponding returnsync, the returnsync instruction adapted to atomically pop a pointer to a monitor off of a standard stack frame, and execute functionality equivalent to a monitorexit and a standard return, the quick instruction to invoke a synchronous method on a receiver object being adapted to use a first operand, the first operand being the number of arguments of the synchronous method, and a second operand representing the synchronous method to be invoked, wherein the quick instruction inherently uses the first operand to obtain a pointer to a monitor of the receiver object, obtains control of the monitor of the receiver object, pushes the pointer of the monitor onto a standard stack frame, and causes execution of the synchronous method using the second operand.

52. The Java-like machine of claim 51 wherein the second operand representing the synchronous method is an index to an entry in a vtable.

53. A byte code implementation comprising a quick byte code adapted to invoke a synchronous method on a receiver object and adapted to use a first operand, the first operand being the number of arguments of the synchronous method, and a second operand representing the synchronous method to be invoked, wherein the byte code inherently uses the first operand to obtain a pointer to a monitor of the receiver object, obtains control of the monitor of the receiver object, pushes the pointer of the monitor onto a standard stack frame, and causes execution of the synchronous method using the second operand.

54. The byte code implementation according to claim 54 in combination with new return byte code implementations of all *return instructions, each return instruction being adapted to atomically pop the pointer to the monitor off of the standard stack frame, and execute functionality equivalent to a monitorexit and a standard return.

55. The byte code implementation according to claim 54 wherein the new return byte code implementations comprise a plurality of new returnsync instructions, one for a return with no parameters, one for ireturn and freturn corresponding to 32-bit returns, one for lreturn and dreturn corresponding to 64-bit returns, and one for areturn corresponding to a 32-bit return.

56. The byte code implementation of claim 53 wherein the second operand representing the synchronous method is an index to an entry in a vtable.

57. A method of quickening invocation of a synchronous method of a platform independent instruction set, the method of quickening invocation comprising:
resolving a synchronous method producing a resolved synchronous method reference to a resolved synchronous method, the resolved synchronous method having a number of arguments and the resolved synchronous method reference having a position in a vtable;
determining the number of arguments of the resolved synchronous method and the position of the resolved synchronous method reference in the vtable; and
replacing a method invocation instruction with a new quick method invocation instruction to invoke the resolved synchronous method;
replacing each return instruction of a variable type in the synchronous method code with a returnsync instruction, the returnsync instruction adapted to atomically pop a pointer to a monitor off of a standard stack frame, and execute functionality equivalent to a monitorexit and a standard return of the same variable type;
wherein the new quick method invocation instruction to invoke the resolved synchronous method on a receiver object, is adapted to use a first operand, the first operand being the number of arguments of the resolved synchronous method, and a second operand representing the resolved synchronous method to be invoked, the quick instruction inherently using the first operand to obtain a pointer to a monitor of the receiver object, obtaining control of the monitor of the receiver object, pushing the pointer of the monitor onto a standard stack frame, and causing execution of the resolved synchronous method using the second operand.

58. A method according to claim 57 wherein the second operand representing the resolved synchronous method is an index to an entry in a vtable.

59. A method according to claim 57 wherein the platform independent instruction set is a Java-like instruction set.

60. A method of invoking an interface method of a platform independent instruction set on a receiver object, the receiver object having a class, the class implementing a number of interfaces of a system, the method comprising:
for each interface implemented by the class providing for the class an interface virtual table (Ivtable), providing for the class a master interface table (MItable) of references to the interface virtual tables corresponding to those interfaces the class implements, the interface virtual table comprising method reference entries of those methods of the interface the class implements;
executing a quick instruction to invoke an interface method on a receiver object, the quick instruction being adapted to use a first operand, the first operand being a number of arguments of the interface method, a second operand representing the interface the interface method is a member of, and a third operand representing the interface method to be invoked, the quick instruction inherently adapted to use the first operand to identify the class, use the second operand to identify the interface, and use the third operand to locate the specific interface method.

61. The method according to claim 60 wherein the second operand representing the interface the interface method is a member of is an index to an entry in an MItable.

62. The method according to claim 60 wherein the third operand representing the interface method to be invoked is an index to an entry in an Ivtable.

63. The method according to claim 60 wherein the platform independent instruction set is a Java-like instruction set.

64. The method according to claim 60 wherein the platform independent instruction set is a Java instruction set.

65. The method according to claim 60 further comprising:
providing a system interface table of all interfaces of a system;
and wherein providing for the class a master interface table comprises using the system interface table as a template for creating the master interface table.

66. The method according to claim 60 wherein providing for the class a master interface table comprises:
eliding NULL entries of the master interface table up to a first non-NULL entry; and
replacing said elided entries with a count of the number of entries elided.

67. A Java-like machine adapted to execute a quick instruction to invoke an interface method on a receiver object, the receiver object having a class, the class implementing a number of interfaces of a system, the Java-like machine being adapted to:
implement an interface virtual table (Ivtable) for each class implemented interface, and to provide for each class a master interface table (MItable) of references to interface virtual tables corresponding to those interfaces the class implements, the interface virtual table comprising method reference entries of those methods of the interface the class implements;
implement the quick instruction to invoke an interface method on a receiver object, and adapted to use a first operand, the first operand being a number of arguments of the interface method, a second operand representing the interface the interface method is a member of, and a third operand representing the interface method to be invoked, the quick instruction inherently adapted to use the first operand to identify the class, use the second operand to identify the interface, and use the third operand to locate the specific interface method.

68. The Java-like machine according to claim 67 adapted to implement Java.

69. The Java-like machine of claim 68 wherein the second operand representing the interface the interface method is a member of is an index to an entry in an MItable.

70. The Java-like machine of claim 68 wherein the third operand representing the interface method is an index to an entry in an Ivtable.

71. The Java-like machine of claim 68 further adapted to:
implement a system interface table of all interfaces of a system; and
use the system interface table as a template in providing for each class a master interface table.

72. The Java-like machine of claim 68 further adapted to:
elide NULL entries of the master interface table up to a first non-NULL entry; and
replace said elided entries with a count of the number of entries elided,
in providing for each class a master interface table.

73. A byte code implementation comprising a quick byte code adapted to invoke an interface method on a receiver object, the receiver object having a class, the class implementing a number of interfaces of a system, the byte code implementation comprising:
for each interface implemented by the class providing for the class an interface virtual table (Ivtable), providing for the class a master interface table (MItable) of references to interface virtual tables corresponding to those interfaces the class implements, the interface virtual table comprising method reference entries of those methods of the interface the class implements;
wherein to invoke an interface method on a receiver object, the byte code is adapted to use a first operand, the first operand being a number of arguments of the interface method, a second operand representing the interface the interface method is a member of, and a third operand representing the interface method to be invoked, the byte code inherently adapted to use the first operand to identify the class, use the second operand to identify the interface, and use the third operand to locate the specific interface method.

74. The byte code implementation of claim 73 wherein the second operand representing the interface the interface method is a member of is an index to an entry in an MItable.

75. The byte code implementation of claim 73 wherein the third operand representing the interface method is an index to an entry in an Ivtable.

76. The byte code implementation of claim 73 further comprising:
providing a system interface table of all interfaces of a system;
and wherein providing for the class a master interface table comprises using the system interface table as a template for creating the master interface table.

77. The byte code implementation of claim 73 wherein providing for the class a master interface table comprises:
eliding NULL entries of the master interface table up to a first non-NULL entry; and
replacing said elided entries with a count of the number of entries elided.

78. A method of quickening invocation of an interface method of a platform independent instruction set, the interface method being a member of an interface, the method of quickening invocation comprising:
resolving an interface method producing a resolved interface method reference to a resolved interface method, the resolved interface method having a number of arguments and the resolved interface method reference having a position in an interface virtual table (Ivtable);
determining the position of a reference to the Ivtable in a master interface table (MItable) of a class, determining the number of arguments of the resolved interface method and determining the position of the resolved interface method reference in the Ivtable; and
replacing a method invocation instruction with a new quick method invocation instruction to invoke the resolved interface method;
wherein the new quick method invocation instruction to invoke the resolved interface method on a receiver object, is adapted to use a first operand, the first operand being the number of arguments of the resolved interface method, a second operand representing the interface the resolved interface method is a member of, and a third operand representing the resolved interface method to be invoked, the quick instruction inherently using the first operand to identify the class, using the second operand to identify the interface, and using the third operand to locate the specific interface method.

79. A method according to claim 78 wherein the second operand representing the interface the resolved interface method is a member of is an index to an entry in an MItable.

80. A method according to claim 78 wherein the third operand representing the interface method is an index to an entry in an Ivtable.

81. A method according to claim 78 wherein the platform independent instruction set is a Java-like instruction set.
